(19) United States
(12) Patent Application Publication
(10) Pub. No.: US 2004/0024667 A1
(43) Pub. Date: Feb. 5, 2004

(54) Method and apparatus for deciding credit

(76) Inventors: James Patrick Quaile, Burnt Hills, NY (US); Srinivas Bollapragada, Niskayuna, NY (US); Prasanthi Venkata Surya Phani Ganti, Guilderland, NY (US); Kannan Ramanathan, Niskayuna, NY (US); Mark David Osborn, Schenectady, NY (US)

Correspondence Address: General Elecrtic Company, CRD Patent Docket Rm 4A59, Bldg. K-1, P.O. Box 8, Schenectady, NY, 12301, US

(21) Appl. No.: 10/209,449

(22) Filed: Jul. 31, 2002

(51) Int. Cl. G06F 17/60

(52) U.S. Cl. 705/35; 705/39

(57) ABSTRACT

An apparatus for deciding credit, the apparatus comprising: a customer identification module adapted for generating customer identification data from salesperson input data; a customer financial data acquisition module adapted for transmitting the customer identification data to a financial data provider and receiving customer financial data from the financial data provider using a communications network; and a credit limit calculator adapted for calculating a credit limit from the customer financial data and from a reasoning model structure using Example Based Evidential Reasoning and for transmitting the credit limit to a credit provider using the communications network.

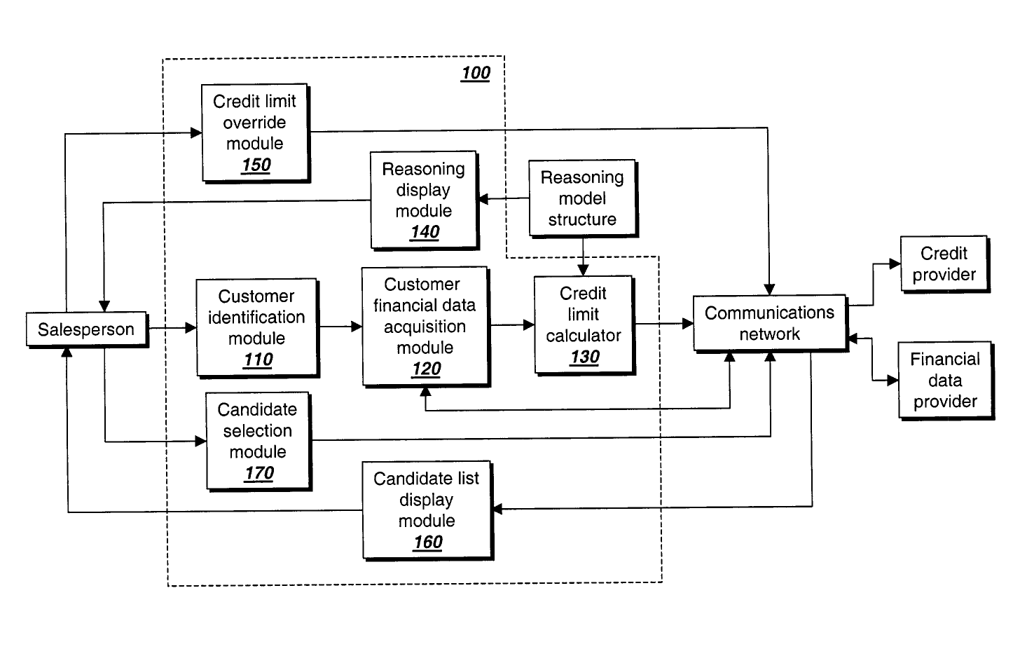

### CROSS REFERENCE TO RELATED PATENT APPLICATIONS

This application is related to commonly assigned patent applications Ser. No. 09/821,526, “Evidential Reasoning System And Method,” and Ser. No. 09/820,675, “Computerized Method For Determining A Credit Line,” both herein incorporated by reference.

### BACKGROUND

The present invention relates generally to the field of deciding credit limits for customers and more specifically to the use of a communication network to acquire financial data for use in automated Example Based Evidential Reasoning.

Many commercial businesses frequently supply their products or services before receiving payment from the customer. In so doing, they assume receivables risk, that is, the risk that a customer cannot, or will not, pay for the goods. To manage this risk, risk models and credit allocation algorithms have been developed.

Typically, a business does not grant credit to all its customers. A credit card transaction or prepayment of all or part of the invoice amount is typically required of customers that are considered to be of high risk. When a customer applies for credit, the business must decide, first, whether to grant credit at all, and second, the extent of such credit (credit limit). In many instances, such decisions are made by human experts and are based on a subjective analysis of financial and organizational information obtained from financial data providers such as, for example, Dun & Bradstreet (Dun & Bradstreet Corporation, New Providence, N.J.).

With the advent of communications networks such as, for example, the Internet, and automated decision tools such as, for example, Example Based Evidential Reasoning, opportunities exist to create systems that calculate credit limits faster, more consistently and at lower cost than can be done with human experts.

### SUMMARY

The opportunities described above are addressed, in one embodiment of the present invention, by an apparatus for deciding credit, the apparatus comprising: a customer identification module adapted for generating customer identification data from salesperson input data; a customer financial data acquisition module adapted for transmitting the customer identification data to a financial data provider and receiving customer financial data from the financial data provider using a communications network; and a credit limit calculator adapted for calculating a credit limit from the customer financial data and from a reasoning model structure using Example Based Evidential Reasoning and for transmitting the credit limit to a credit provider using the communications network.

### DRAWINGS

These and other features, aspects, and advantages of the present invention will become better understood when the following detailed description is read with reference to the accompanying drawings in which like characters represent like parts throughout the drawings, wherein:

The FIGURE illustrates a block diagram of an apparatus for deciding credit in accordance with one embodiment of the present invention.

### DETAILED DESCRIPTION

In accordance with one embodiment of the present invention, the FIGURE illustrates a block diagram of an apparatus 100 for deciding credit. Apparatus 100 comprises a customer identification module 110, a customer financial data acquisition module 120, a credit limit calculator 130, a reasoning display module 140, and a credit limit override module 150. In operation, customer identification module 110 generates customer identification data from salesperson input data provided by a salesperson. Customer financial data acquisition module 120 transmits the customer identification data to a financial data provider and receives customer financial data from the financial data provider using a communications network. From the customer financial data and from a reasoning model structure, credit limit calculator 130 calculates a credit limit using Example Based Evidential Reasoning and transmits the credit limit to a credit provider using the communications network. Reasoning display module 140 then displays the credit limit and intermediate reasoning results corresponding to nodes of the reasoning model structure for evaluation by the salesperson. In the event the salesperson wishes to override the automatic decision, credit limit override module 150 receives a salesperson credit limit override, provided by the salesperson, and transmits the salesperson credit limit override to the credit provider.

In another embodiment of the present invention, apparatus 100 further comprises a candidate list display module 160 and a candidate selection module 170. In operation, if the transmitted customer identification data is insufficient to locate a unique database entry, candidate list display module 160 receives candidate list data from the financial data provider using the communications network and displays the candidate list data for perusal by the salesperson. Candidate selection module 170 then receives a salesperson candidate selection made by the salesperson and transmits the salesperson candidate selection to the financial data provider using the communications network

Customer identification module 110, customer financial data acquisition module 120, credit limit calculator 130, reasoning display module 140, credit limit override module 150, candidate list display module 160 and candidate selection module 170 individually comprise any electrical or electronic device or system capable of performing the indicated functions. Typical embodiments of apparatus 100 implement customer identification module 110, customer financial data acquisition module 120, credit limit calculator 130, reasoning display module 140, credit limit override module 150, candidate list display module 160 and candidate selection module 170 as software components executed by a digital computer.

Evidential Reasoning is an artificial intelligence methodology that generally starts with a hierarchical description of a decision process used in a particular field, such as, for example, business, engineering, or medical diagnostics. The hierarchical description is used to develop a reasoning model structure represented by a plurality of nodes. Each node in the reasoning model structure represents an intermediate or final consideration and opinion used in the decision process. Each node contains a number of attributes describing factors to be considered for that node. Each attribute has a number of possible linguistic evidential values. The linguistic evidential values are converted to numeric evidential values at the nodes. The numeric evidential values express a degree to which the linguistic evidential values support a particular hypothesis for the attributes. For example, there can be a high belief, a medium belief, or a low belief that the linguistic evidential values support the hypothesis. The numeric evidential values for all of the attributes in a node are combined and used to formulate an opinion for the node. The opinion from each node is then propagated to the next higher level node where it becomes the linguistic evidential value for the appropriate attribute in that higher level node. The linguistic evidential values at the higher level nodes are then converted to numeric evidential values and combined at the nodes to formulate additional opinions. This process continues until a final opinion is formulated at the highest level node in the model structure.

Example Based Evidential Reasoning is an Evidential Reasoning methodology wherein the numerical evidential values for a given application are discovered by optimizing a performance index related to a set of examples of final opinions provided by human experts and to a set of calculated final opinions provided by the methodology.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An apparatus for deciding credit, said apparatus comprising:
a customer identification module adapted for generating customer identification data from salesperson input data;
a customer financial data acquisition module adapted for transmitting said customer identification data to a financial data provider and receiving customer financial data from said financial data provider using a communications network; and
a credit limit calculator adapted for calculating a credit limit from said customer financial data and from a reasoning model structure using Example Based Evidential Reasoning and for transmitting said credit limit to a credit provider using said communications network.

2. The apparatus of claim 1 further comprising a reasoning display module adapted for displaying said credit limit and intermediate reasoning results corresponding to nodes of said reasoning model structure.

3. The apparatus of claim 2 further comprising a credit limit override module adapted for receiving a salesperson credit limit override and transmitting said salesperson credit limit override to said credit provider.

4. The apparatus of claim 1 further comprising:
a candidate list display module adapted for receiving candidate list data from said financial data provider using said communications network and for displaying said candidate list data; and
a candidate selection module adapted for receiving a salesperson candidate selection and transmitting said salesperson candidate selection to said financial data provider using said communications network

5. An apparatus for deciding credit, said apparatus comprising:
a customer identification module adapted for generating customer identification data from salesperson input data;
a customer financial data acquisition module adapted for transmitting said customer identification data to a financial data provider and receiving customer financial data from said financial data provider using a communications network;
a credit limit calculator adapted for calculating a credit limit from said customer financial data and from a reasoning model structure using Example Based Evidential Reasoning and for transmitting said credit limit to a credit provider using said communications network;
a reasoning display module adapted for displaying said credit limit and intermediate reasoning results corresponding to nodes of said reasoning model structure; and
a credit limit override module adapted for receiving a salesperson credit limit override and transmitting said salesperson credit limit override to said credit provider.

6. The apparatus of claim 5 further comprising:
a candidate list display module adapted for receiving candidate list data from said financial data provider using said communications network and for displaying said candidate list data; and
a candidate selection module adapted for receiving a salesperson candidate selection and transmitting said salesperson candidate selection to said financial data provider using said communications network

7. A method for deciding credit, said method comprising:
generating customer identification data from salesperson input data;
transmitting said customer identification data to a financial data provider using a communications network;
receiving customer financial data from said financial data provider using said communications network;
calculating a credit limit from said customer financial data and from a reasoning model structure using Example Based Evidential Reasoning; and
transmitting said credit limit to a credit provider using said communications network.

8. The method of claim 7 further comprising displaying said credit limit and intermediate reasoning results corresponding to nodes of said reasoning model structure.

9. The method of claim 8 further comprising:
receiving a salesperson credit limit override; and
transmitting said salesperson credit limit override to said credit provider using said communications network.

10. The method of claim 7 further comprising:
receiving candidate list data from said financial data provider using said communications network;
displaying said candidate list data;
receiving a salesperson candidate selection; and
transmitting said salesperson candidate selection to said financial data provider using said communications network

11. A method for deciding credit, said method comprising:
generating customer identification data from salesperson input data;
transmitting said customer identification data to a financial data provider using a communications network;
receiving customer financial data from said financial data provider using said communications network;
calculating a credit limit from said customer financial data and from a reasoning model structure using Example Based Evidential Reasoning;
transmitting said credit limit to a credit provider using said communications network;
displaying said credit limit and intermediate reasoning results corresponding to nodes of said reasoning model structure;
receiving a salesperson credit limit override; and
transmitting said salesperson credit limit override to said credit provider using said communications network.

12. The method of claim 11 further comprising:
receiving candidate list data from said financial data provider using said communications network;
displaying said candidate list data;
receiving a salesperson candidate selection; and
transmitting said salesperson candidate selection to said financial data provider using said communications network

13. A computer readable medium encoded with instructions for a computer to implement a method comprising:
generating customer identification data from salesperson input data;
transmitting said customer identification data to a financial data provider using a communications network;
receiving customer financial data from said financial data provider using said communications network;
calculating a credit limit from said customer financial data and from a reasoning model structure using Example Based Evidential Reasoning; and
transmitting said credit limit to a credit provider using said communications network.

14. The computer readable medium of claim 13 wherein said method further comprises displaying said credit limit and intermediate reasoning results corresponding to nodes of said reasoning model structure.

15. The computer readable medium of claim 14 wherein said method further comprises:
receiving a salesperson credit limit override; and
transmitting said salesperson credit limit override to said credit provider using said communications network.

16. The computer readable medium of claim 13 wherein said method further comprises:
receiving candidate list data from said financial data provider using said communications network;
displaying said candidate list data;
receiving a salesperson candidate selection; and
transmitting said salesperson candidate selection to said financial data provider using said communications network

17. A computer readable medium encoded with instructions for a computer to implement a method comprising:
generating customer identification data from salesperson input data;
transmitting said customer identification data to a financial data provider using a communications network;
receiving customer financial data from said financial data provider using said communications network;
calculating a credit limit from said customer financial data and from a reasoning model structure using Example Based Evidential Reasoning;
transmitting said credit limit to a credit provider using said communications network;
displaying said credit limit and intermediate reasoning results corresponding to nodes of said reasoning model structure;
receiving a salesperson credit limit override; and
transmitting said salesperson credit limit override to said credit provider using said communications network.

18. The computer readable medium of claim 17 wherein said method further comprises:
receiving candidate list data from said financial data provider using said communications network;
displaying said candidate list data;
receiving a salesperson candidate selection; and
transmitting said salesperson candidate selection to said financial data provider using said communications network
